(19) United States
(12) Patent Application Publication
(10) Pub. No.: US 2002/0161685 A1
(43) Pub. Date: Oct. 31, 2002

(54) Broadcasting information and providing data access over the internet to investors and managers on demand

(76) Inventor: Michael Dwinnell, Kemp, TX (US)

Correspondence Address: Michael Dwinnell, iDBS, Inc., 3141 North Hood Street, Dallas, TX, 75201, US

(21) Appl. No.: 09/931,168

(22) Filed: Aug. 17, 2001

Related U.S. Application Data
(60) Provisional application No. 60/286,002, filed on Apr. 25, 2001.

(51) Int. Cl. G06F 17/60

(52) U.S. Cl. 705/36

(57) ABSTRACT

A system and method for providing real time information access to investors is disclosed. Embodiments of the present invention as disclosed collect live productivity data and streaming media information broadcast from remote sites of interest (such as oil and gas drilling locations, construction sites, etc.) in real-time into a collection and distribution network that delivers this data and information to investors and managers via the Internet via a dynamic web page interface. Such web pages according to the present invention allow the user to select and set the data and streaming media, including real-time video images, from an array of choices as well as access time-stamped past data and streaming media. According to preferred embodiments of the invention, satellite transmissions are employed to send the data and information from the remote sites.

### RELATED APPLICATIONS

This application claims the benefit of priority from U.S. Provisional Patent Application Serial No. 60/286,002, filed Apr. 25, 2001, the entirety of which is herein incorporated by reference.

### FIELD OF THE INVENTION

The present invention relates to a system and method for providing real time information access to investors and business managers. More particularly, the present invention pertains to a system and method for broadcasting productivity data and live streaming video for remote site activity related to a particular business venture to a set of investors or managers such that they can observe and review the progress of such ventures on demand. Most particularly, preferred embodiments of the present invention relate to the providing of real time information and data regarding oil and gas drilling activities taking place at remote well sites to investors and managers.

### BACKGROUND OF THE INVENTION

Investors in more traditional investment endeavors, such as stocks and bonds, have nearly continuous and unlimited access to information regarding their investments. In particular, due to the proliferation of the Internet trading, e-brokerage services and dedicated financial news outlets (such as, for example, Bloomberg Television and CNNfn.com), an investor in stocks and bonds is provided with continuously updated breaking news of interest and reports regarding the performance of his or her investment. This information access, however, is not readily available to all types of investors.

As will be appreciated by one skilled in the art, there are certain types of information that investors desire to know but which cannot be adequately reflected by productivity numbers and other quantitative data. For example, oil well investors commonly desire to confirm visually that a given drill site is actually being drilled at a given moment. Similarly, with respect to livestock ventures, for example, investors often desire to see if, for example, their sheep at a particular location appear healthy despite a very cold winter (and thus likely to produce quality wool). The need or desire for such “qualitative” information inherently arises in many other industries, including, but not limited to, crop production, mining, oil drilling, forestry, and construction. Such qualitative information typically can be obtained only by traveling to sites, often located in remote locations, where significant venture activity is taking place to view the transpiring of those activities first hand.

Similarly, managers, which include operators, decision makers, etc., suffer the similar problems to those encountered by investors when those managers are in charge of ventures in similar industries in which a large portion of activity takes place at multiple, remote sites. While the need for the manager to witness certain events first hand may be significant, inevitably managers often cannot be at every place when necessary. The need for such qualitative information, therefore, often goes unmet.

Generally speaking, closed-circuit video/television equipment is a known solution for receiving image-based qualitative information from a remote site. Unfortunately, closed-circuit video/television is not an ideal solution for the problems encountered by investors and managers because it suffers from several inherent drawbacks. First, closed circuit video uses analog and/or digital cameras to send a television signal over a dedicated communication line to a television monitor. Unfortunately, there presently is no mechanism for a manager or investor to access video-based information on demand using closed-circuit television signal. For example, while the video signal can be stored on video tape for viewing at later time (tape delay), there is not an efficient way for playback of such tapes to be initialized from the monitor end. Additionally, the nature of closed circuit television requires a viewer to have access to a specially connected monitor. Thus, viewers cannot access information via closed-circuit television whenever they want from wherever they may be. Furthermore, live closed-circuit television signals cannot be readily combined or merged with objective or empirical data in an efficient manner.

Due to the above described bottleneck in the distribution of operations information, the same industries as mention above have traditionally suffered from a disconnect with potential financing investors. For example, the Energy Information Agency (EIA) has reported that U.S. oil producers fall into two groups; the 29 “Major” oil producers and all others. While the large, conglomerate “Major” oil companies may be insulated from the ill effects of this disconnect with investors, the balance of the industry, comprising the “non-Major” companies (such as independent operators), does. Thus, the “non-Majors” experience higher costs of obtaining capital due to the inability of the non-institutional investor to obtain information as described above. A more efficient manner for disseminating information regarding their oil ventures would not only help smaller operators raise external capital more easily, but also push them into making more cost-effective decisions and utilizing internal capital more profitably because information regarding their operations flows more easily to remote investors. This analysis applies similarly in various other industries, including the aforementioned crop production, mining, oil drilling, forestry, construction, and ranching/livestock raising industries.

Therefore, there is a need in the art for improved mechanisms whereby investors in and managers of certain business ventures can be provided information on demand regarding, for example, performance and status, that overcomes the above-described and other inherent disadvantages left unsolved by the prior art.

### SUMMARY OF THE INVENTION

Accordingly, the present invention is an improvement over the prior art systems methods by which investors in, and managers of, business activities taking place at remote sites, such as oil and gas drilling sites, obtain qualitative and quantitative information regarding those business activities.

In light of the drawbacks inherent in the prior art, it is an object of the present invention to facilitate a greater and more responsive transactional flow of capital resources between investors in financial markets and any business venture having significant activity of interest taking place at remote sites, such as oil and gas drilling sites, that overcomes the above-described and other disadvantages inherent in the prior art.

As such, it is an object of the present invention to provide an Internet-based system that delivers live productivity data and streaming video from remote sites anywhere in the world to investors and managers on demand. Further, it is an object of the present invention that such an Internet-based system eliminates distance and communication barriers, provides accountability for remote operations, and expands the potential investor market for industries that do not have highly visible and accessible investment data.

Further, it is an object of the present invention to combine real-time productivity data with live video and audio to enable investors in and managers of ventures comprising significant activity taking place at remote sites to make informed real-time decisions regarding their ventures.

Likewise, it is an object of the present invention to provide a mechanism of accountability for remote investment activity by offering an auditing tool to remote investors which ensures that funds are being spent on previously agreed upon activities at defined locations.

Similarly, it is also an object of the present invention to combine video, audio and alphanumerical data into a single interface for use by investors and managers to gain on demand, real-time access to the status of activities at a remote site of interest.

In response to the above-described and other needs and objects, the present invention collects live productivity data and streaming media information broadcast from remote sites of interest (such as oil and gas drilling locations, construction sites, etc.) in real-time into a collection and distribution network that delivers this data and information to investors and managers via the Internet via a dynamic web page interface. Such web pages according to the present invention allow the user to select and set the data and streaming media, including real-time video images, from an array of choices as well as access time-stamped past data and streaming media.

As herein described, the present invention enables investors to confirm visually in real-time over the Internet the status of a venture or a particular part of a venture as well as to access other pertinent data simultaneously (i.e., information including, but not limited to, the depth, direction, and drilling rate of an oil and gas well being drilled horizontally out from a vertical wellbore, the number of productive gas zones encountered at present and the current rate of natural gas being produced while drilling ahead, or the development and progress of a residential multi-family housing complex being built at a remote location). Similarly, for venture managers of activities at remote locations, the dynamic interface web site allows oversight of multiple remote sites at a single time with the visual information and pertinent data. The result is a flow of productivity or performance information to existing or potential investors and operations feedback to managers whenever they want it and to wherever they are located. This information thereby allows important information that can normally be gained only from intimate activity with a venture, such as from visiting an oil drilling site or staying in direct contact with persons at the site, to be continuously provided via an electronic data network to remote investors in an efficient manner.

As described above, according to preferred embodiments of the present invention, the data provided over the Internet with the video feeds can include any traditional quantitative, factual, or descriptive data that would be of interest to investors. For example, for an oil an gas drilling venture information and data relating to the geographic coordinates of a particular site, the current drilled depth, the current drilling rate, current rock formations, etc., can be updated on a web site in essentially real time for review by investors. Similarly, staying with the example of an oil and gas drilling venture, data from third-party sources (such as an electronic quote regarding the current market price of crude oil) can be integrated with the streaming media and data obtained from the remote sites and provided to users of the web site.

In preferred embodiments of the present invention, the performance and productivity data includes live streaming video of one or more remote sites of interest to the investors and/or managers. This allows investors and managers to virtually go for “on site” inspections of ventures to which they are, or considering becoming, financially involved or are, in the case of mangers, responsible for. As will be appreciated by one skilled in the art, live video feeds can effectively convey those certain types of information that investors and managers desire to know but which cannot be adequately reflected by productivity numbers and other quantitative data.

According to preferred embodiments of the present invention, the dynamic interface web site facilitates immediate investment transactions between investors and business ventures spanning various industries by allowing investors to purchase shares of ventures electronically. This reduces the time cost component of funding a given venture during its life cycle, and increases the capital resource pool available to such ventures.

Further, according to preferred embodiments of the invention, investors and managers can use a remote site event advisor tool over the interactive web site to request notifications regarding particular events of interest. The advisor tool according to such embodiments enables users to set alert status parameters to indicate what activities at a given remote site is of interest. Once these activities occur at the remote site, the investor or manager is notified when the parameters are met. For example, an investor in an oil well could be provided with selectable alert parameters including that the drilling is nearing a target zone, that a gas kick has been reported, oil has been struck, a significant drill rate change has occurred and that a particular depth has been exceeded. Setting these parameters could then cause the network to recognize when it compiles relevant information and data for such an event and then generate an alert to notify the appropriate user.

As will be readily appreciated by one skilled in the art, the dynamic interface web site according to the present invention allows oversight of multiple remote sites at a single time without requiring frequent, unnecessary “check up” trips to those sites, thus providing a more efficient allocation of resources. Thus, the present invention is particularly suitable for areas of industry that typically involve significant activity at one or more remote sites, such as various drilling sites in speculative oil and gas drilling ventures as is described below as a preferred embodiment.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings with like reference numbers representing corresponding parts throughout:

FIG. 1 is a schematic diagram depicting a data and streaming media collection and distribution network for providing information on demand to investors and managers from various remote sites according to embodiments of the present invention;

FIG. 2 is a schematic diagram depicting a system adapted to collect data and streaming media from a remote site according to embodiments of the present invention;

FIG. 3 is a schematic diagram depicting the components of a central collection and distribution system according to one embodiment of the present invention;

FIG. 4 is a screenshot depiction of a client web browser display of a web page for viewing data and multiple streaming media feeds transmitted from a remote site on demand over the Internet according to preferred embodiments of the present invention;

FIG. 5 is a screenshot depiction of a client web browser display of a web page for viewing detailed data and a single detailed streaming media feed transmitted from a remote site on demand over the Internet according to preferred embodiments of the present invention;

FIG. 6A and FIG. 6B are screenshot depictions of client web browser displays of web pages for viewing and interacting with the remote site event advisor according to preferred embodiments of the present invention; and

FIG. 7 is a diagram of a portable remote site system integrated into a trailer according to one preferred embodiment of the present invention.

### DESCRIPTION OF THE PREFERRED EMBODIMENT

Reference is now made in detail to the preferred embodiment of the present invention, examples of which are illustrated in the accompanying drawings. While the description herein contained in the discussion of the preferred embodiments relates specifically to ventures in oil and gas drilling and activities at remote drilling sites, one of ordinary skill in the art will readily recognize that the concepts of the present invention can and are intended to be readily and advantageously applied to various other industries that comprise significant remote site activity and engage the financial resources of investors or the attentions of operations managers across various localities. Suitable industries for application of the present invention include, but are not limited to, crop production, mining, oil and gas drilling, forestry, construction, environment monitoring and livestock raising. The present invention, however, has particular utility in the oil and gas industry as is explained below and therefore the use of the present invention to disseminate information and data from remote oil and gas drilling sites is a preferred embodiment.

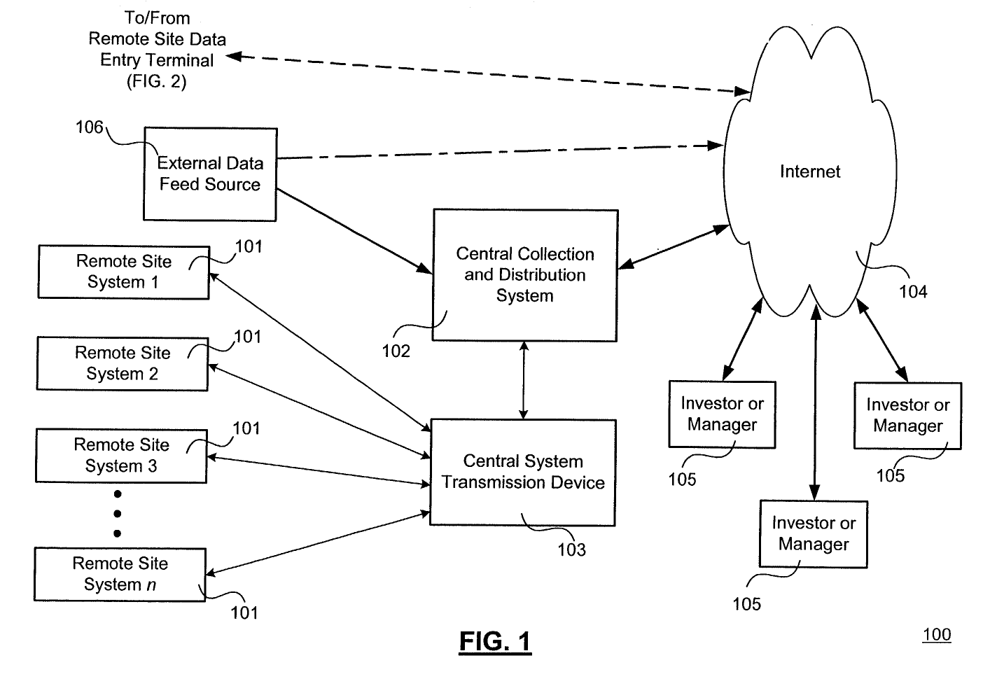

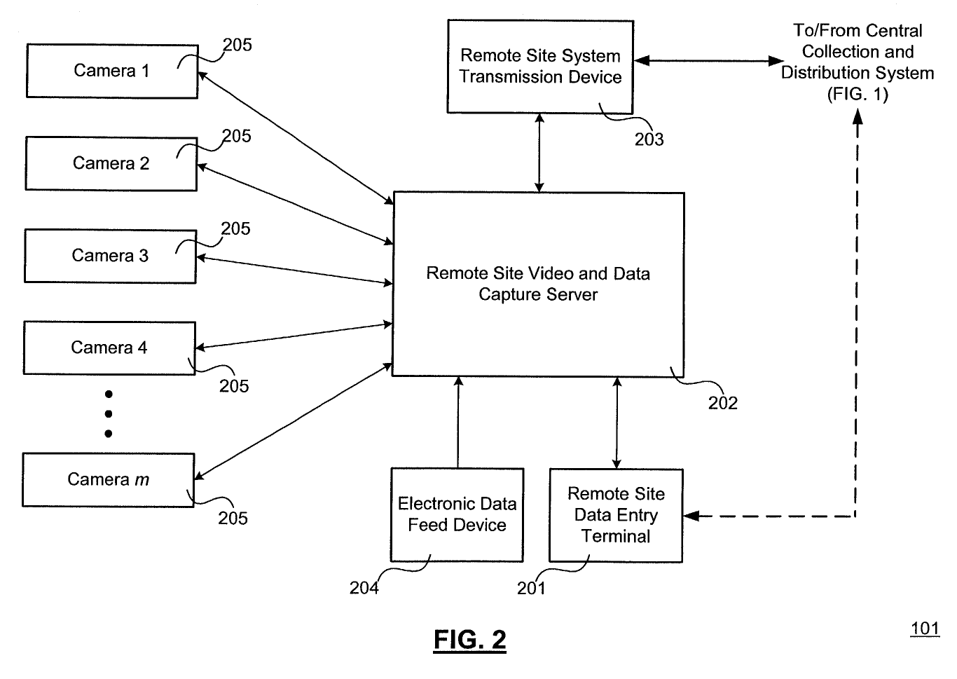

Referring now to FIG. 1 there is schematically depicted a data and streaming media collection and distribution network 100 for providing information and data on demand to various investors and managers 105 from a plurality of remote site systems 101 according to one preferred embodiment of the present invention. As is apparent from FIG. 1, the network 100 can be expanded or contracted to include any number of remote site systems 101 or investors/managers 105 as is necessitated. Each remote site system 101 gathers information and data from a particular remote site (i.e., an oil and gas drilling site or rig) and transmits the information and data to a central collection and distribution system 102 at least partially in the form of streaming media, and preferably digital streaming video.

Streaming media is a technology that transfers multi-media information such that it can be processed as a steady and continuous stream (like a traditional television or radio signal). Streaming technologies are becoming increasingly important with the growth of the Internet because it limits the importance of users having high speed communication access to download large multimedia files quickly. With streaming media, the receiving end (typically a computer running a web browser and appropriate plug-in) can start reading and displaying the data before the entire file has been transmitted.

For streaming to work, the client side receiving the data must be able to collect the data and send it as a steady stream to the application that is processing the data and converting it to sound or pictures. This means that if the streaming client receives the data more quickly than required, it needs to save the excess data in a buffer. If the data doesn't come quickly enough, however, the presentation of the data will not be smooth.

In the embodiment of the invention depicted in FIG. 1, the data and information collected by the remote site systems 101 is streamed twice. First, a continuous stream is sent from each remote site system 101 to the central collection and distribution system 102 via the central system transmission device 103 (such as a high speed modem, LAN, WAN or VSAT satellite transmitter/receiver). At the central collection and distribution system 102, the streamed media content and data is organized and stored according to time stamp. In the event that a particular investor/manager 105 desires to see the streamed media content and data in real-time, the media content is immediately re-streamed from the central system 102 through a distributed network (such as the Internet 104 as shown) to client devices (e.g., personal computers running web browsers) of the requesting investor/manager 105. Furthermore, since the received streams are time stamped (as described below with respect to the remote site system 101 and FIG. 2) and stored according to those time stamps, an investor/manager 105 can request audio and video data from any prior time period and the central system will re-stream the stored information and data from the prior time period over the Internet on demand.

To the investor, live streaming video transmission confirms the deployment of his assets and forces the accountability of his broker and/or the venture itself, thus galvanizing trust between the investor and the broker/venture. Such on demand streaming video broadcasts from, for example, an oil and gas drilling rig provides the visual proof to investors that a site is being drilled and increases the knowledge and awareness levels of investors and potential investors in the business of oil and gas exploration and production. Additionally, the web site-based investor access according to the present invention allows investors to make visual observations of the drill site activities to ensure operations are being conducted in accordance and compliance with respective operating agreements and governing regulations.

On the other hand, a manager (or owner/operator) is primarily interested in the efficient use of resources (in the case of oil gas drilling, his drilling rig and personnel). With the ability to see what is transpiring at each remote sight, the rig owner can ensure his rig is being used efficiently. Similarly, a manager with access to live streaming video can make expedient decisions including: adjusting drilling parameters more rapidly, adjusting casing scheduling based on drilling fluid conditions, noting drilling conditions and bit wear more readily, maintaining substantially real-time communication with the rig operator and crew, and initiating immediate responses in cases of emergency. Such on demand remote site monitoring thus enables an operator, site-engineer and emergency crews to respond more quickly to site hazards and unexpected events such as oil well blowouts, fires, hazardous material and chemical spills and draw work failure, hydraulics failure, rig crew accidents and injury. Additionally, a drill site manager benefits from remote drill site viewing according to the present invention by using the same manpower to manage more drilling sites or rigs, thereby reducing variable operating expenses and creating a greater opportunity to compete for desirable leases and drilling prospects.

Furthermore, other indirect benefits are provided by use of the present invention. In the present example of oil and gas drilling, not all well operators operate as cleanly or as safely as others. Thus, the ability to obtain streaming media information and related data from a remote location on demand could be utilized advantageously by third parties such as government safety and environmental agencies and insurance companies.

Referring again to FIG. 1, it is also shown that the central system 102 (either directly or via the Internet 104) can receive electronic data of various types from external data feed sources 106 (as well as from the remote site data entry terminals 201 as will be described below with respect to FIG. 2). For example, a suitable external data feed source 106 can be a real-time information provider such as a financial news ticker service that electronically provides up to the minute pricing on stocks and commodities (including the current market price on a barrel of crude oil). Alternatively, a suitable external data feed source 106 could provide real-time weather forecasting for each remote site location.

Referring now to FIG. 2, there is schematically depicted in more detail a remote site system 101 adapted to collect data and streaming media from a remote site location (such as a oil and gas drilling rig location) according to one preferred embodiment of the present invention. The remote site system 101 comprises a remote site video and data capture server 202 (hereinafter referred to as a remote site capture server 202 or “RSCS 202”) in electronic communication with a plurality of cameras 205 positioned strategically about the remote site.

In preferred embodiments, multiple camera angles and locations are provided to allow the investors and managers to navigate about a site. For example, cameras for recording the streaming video can be adapted to intermittently pan across a preset area and thus provide a wider range of vision. Additionally, in more preferred embodiments, the cameras can be adapted for remote controlling by investors and managers over the Internet (when viewing real-time streaming video feeds). The number of cameras and different angles or views, of course, should be set up logically depending upon the physical dimensions and parameters of a given remote site location as well as the business activities that take place there.

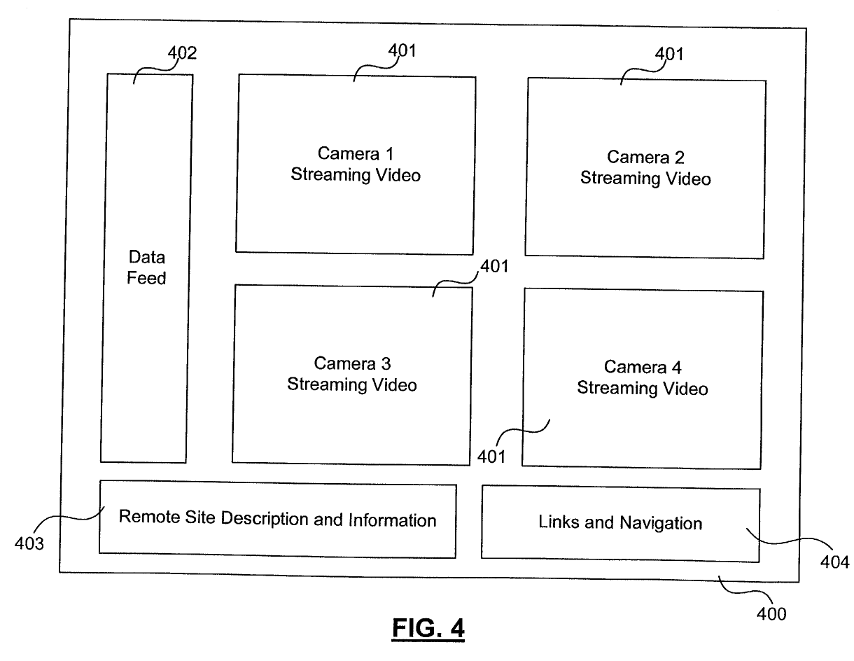

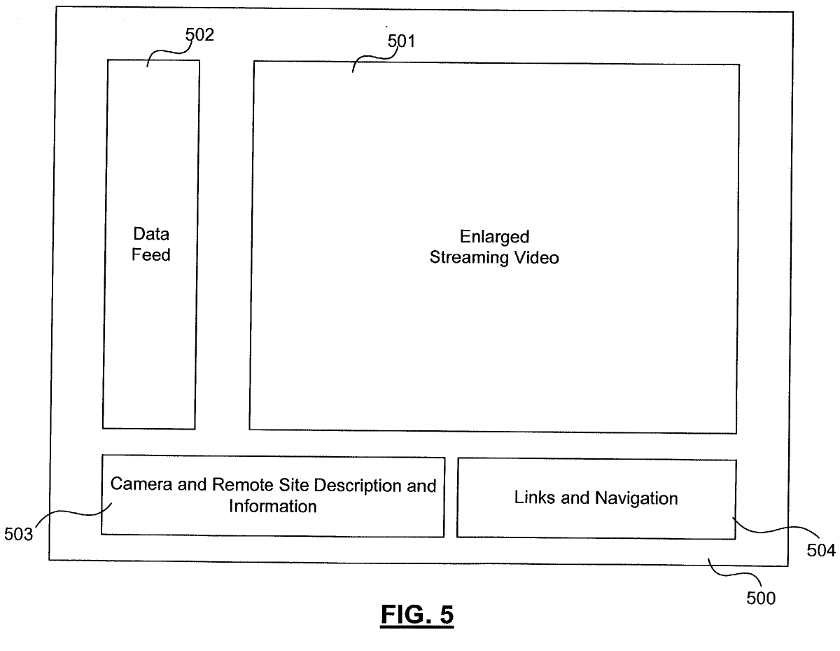

For example, four separate digital video camera locations can be used simultaneously at a single oil and gas drilling site. A first camera could give a wide angle of the drilling rig and surrounding area such that one could generally view the activities going on about the rig. A second camera could provide a close up view of the drilling rig floor such that one could watch streaming video (live or time-delayed) of workers changing drill pipes and bores as they go into and come out of the drilling hole. A third camera could be mounted on top of the derrick to provide a birds-eye view of the drilling floor. Finally, a fourth camera could be mounted so as to give a view of the arrival and departure of equipment and tanker trucks. Preferably, investors would be able to select a subset of several (or all) cameras for simultaneous viewing (such as in a tiled manner as is depicted in FIG. 4) or a single camera for viewing alone (as is depicted in FIG. 5).

The remote site capture server 202 preferably comprises a central processing unit, such as in the form of a personal computer having an Intel or AMD based microprocessor, equipped with various hardware cards to capture video and audio streams and other data from the target site. Preferably, the remote site capture server is equipped with multiple video capture cards (i.e., one for each camera) to increase the speed with which raw video frames can be brought into the RSCS 202. Similarly, when sound is recorded at the remote site, multiple sound cards can be employed. A streaming media encoder then processes the raw frames/sounds into digital video (or composite audio/video) digital streams.

Data acquired from multiple sources can also be stored locally in the RSCS and transmitted with the streams to the central collection system. With respect to oil and gas drilling sites, such data can include relevant information such as weather information (forecasts, temperature, humidity, wind, barometric pressure, etc.) or operating data obtained automatically from an electronic data feed device 204 such as a drilling rig computer (monitoring/controlling drill depth, rotation speed, oil pumping rate, etc.) or inputted manually by an operator using a data entry terminal 201 located directly at the remote site. In alternative embodiments, data entered manually via the data entry terminal 201 can be transmitted independently to the central system 100 (i.e., bypassing the RSCS 202) as shown in dashed lines in FIG. 1 and FIG. 2. Thus, information provided by, for example, an equipment operator at the remote site can be directly loaded into the central system and stored in the database or archive system for coupling with real-time productivity data and video according to date and time stamp. Thus, even though the streaming media information and data is transmitted separately, the cached information and data can be delivered to the dynamic user-defined web page on demand in either a real-time or delayed.

The collected data and streams are then compressed and/or encoded and transmitted back to the central collection system 100 for immediate use (re-streaming) and/or archival. Preferably, the remote site system 101 also includes a storage medium (not explicitly shown in FIG. 2) for archiving a local copy of said collected data and streams such that such information and data will not be permanently lost in the case oc communication problems with the central system 100. The remote site system 101 further includes a remote site transmission device 203 for connecting to and sending streaming media information and other data to the central system 102. Preferably, the transmission device 203 should be capable of 64 Kb/s or greater telecommunication bandwidth and can comprise a cellular or land-line high speed modem, microwave, ADSL, ISDN line, LAN/WAN, etc., and most preferably comprises a portable VSAT satellite receiver/transmitter and antenna. In this most preferred embodiment, the method of delivery utilizes a global network of satellites for the transmission of the streamed video and data to the central system 102. As will be readily appreciated by one skilled in the art, the use of portable satellite antennas and receiver/transmitters eliminates the need for the remote site capture server to be near traditional communication lines or within service areas of cellular data networks. Thus, data delivery via satellite networks enables the present invention to expand to remote locations that would otherwise be inaccessible.

MPEG graphics and video encoding, a known multi-media standard, offers resolutions of 720×480 and 1280×720 at 60 fps with full CD-quality audio. This is sufficient for all the major TV standards, including NTSC, and even HDTV. For example, MPEG-2, a known version of the MPEG encoding standard, is currently used by DVD-ROMs because it can compress a 2 hour video into a few gigabytes of digital data. Additionally, decompressing an MPEG data stream requires only modest computing power such that the typical personal computer has no problems receiving MPEG data streams (encoding video in MPEG format requires significantly more processing power).

MPEG-4 is a graphics and video compression algorithm standard that is based on the MPEG-1 and MPEG-2 video compression standards and Apple QuickTime technology. Wavelet-based MPEG-4 files are smaller than JPEG or QuickTime files, so they are designed to transmit video and images over a narrower bandwidth and can mix video with text, graphics and 2-D and 3-D animation layers.

According to embodiments of the present invention, the remote site capture server 202 compresses video/audio obtained from the remote site cameras 205 using software based encoders. Thus, new, advanced compression standards can be easily adapted as they are introduced. However, given current available technology, MPEG-4 is the preferred compression standard according to the present invention due to the quality of video it provides in combination with low bandwidth usage, thus allowing multiple video sources to be streamed at a given time.

Additionally, using MPEG-4 encoding, video, audio, weather data, and rig information that is collected at the remote site capture server 202 can be streamed together to the central system 102 for disbursal through the interactive investment website in combination with the video/audio feed.

In embodiments of the present invention that employ satellite transmission of the productivity data and streaming video from the remote site systems 101, global positioning satellite verification as well as a date and time stamp is merged into each stream, and thus is cached in central system 102 for on-demand replay. Additional satellite transmission information that can be transmitted to and stored in the central system includes; satellite name, number and coordinates, uplink connection and transmission status, and time sequence verification.

The time stamp allows the user to replay cached video by time sequence and by drilled depth sequence. This feature allows users to select and review video of drilling operations with corresponding drilling data and events for analysis with geological findings and mud loggers report within a specified sequence.

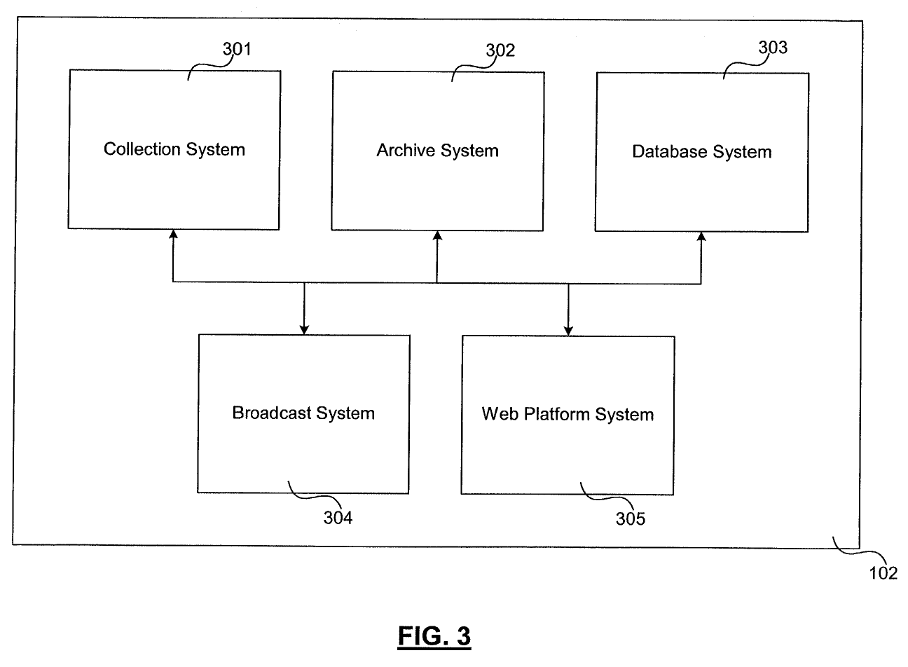

FIG. 3 schematically depicts the components of a central collection and distribution system 102 according to one embodiment of the present invention. As shown in FIG. 3, the central system 102 is comprised of a plurality of computerized systems in electronic intercommunication, including: a collection system 301, an archive system 302, a database system 303 a broadcast system 304 and a web platform system 305. Each of the systems 301-305 that comprise the central system 102 are composed of suitable servers, storage devices (including databases), memory devices and support hardware as is known in the art of computer networks to achieve the functions of each system 301-305.

Incoming streamed media is received by the central system transmission device 103 and sent directly to the collection system 301 where it is identified. The stream is then duplicated and sent to the archive system 302 and the broadcast system 304. Once in the archive system 302, the information and data is stored according to time stamp and remote site of origination so as to be readily accessible by users.

The stream sent to the broadcast system 305 is made available on several streaming media servers in various streaming media formats, including MPEG format, Real Video format, and Microsoft Windows Media format. The database system 303 stores all transaction data collected from the remote site system 101 as well as stores administrative information regarding registered users, etc.

The web platform system 305, comprising one or more web servers, communicates directly with each user's computer (running a web browser application) via the Internet and retrieves and serves, in a suitable hardware independent page description language (such as HTML, XML, and java), requested data from the database system 303, live streaming broadcasts and associated data from the broadcast system 304, and archived streams and associated data from the archive system 302.

In the manner as described above, information and data from each remote site location is transported over a telecommunications link to the central system 102, and there converted by the web platform system 305 into IP data, and, upon demand by mangers or investors, made available on the world wide web as an interactive dynamic web site (as described in detail below) via high speed internet connections for viewing with a web browser.

The interactive dynamic web site is comprised of various web pages that are uniform in design to promote ease of use and navigation for all investors and managers. The web site includes individual or multiple web pages such as: a main page having visually obvious links to other distinct pages; investment pages showing level of remaining investment opportunity with transactional capabilities for particular participating ventures; an online subscription page allowing for users to become members web site; prospect pages showing information relative to current of future oil wells; operator's pages showing historical and pertinent information regarding each participating operator's prior drilling activities; interactive streaming media and data pages showing on-demand video and data (live or archived) from the drill site; a user defined parameter page allowing the delivery of requested information direct to the users internet browser; and a password page for accessing the web site, allowing for 24 hour free guest usage and viewing of pages at the guest site.

Retrieval by web site users (investors and managers) of information and data stored in the archive system 302 or the database system 303 is controlled by standard authentication and authorization protocols. Users sign up for access to certain restricted features of the dynamic web site and receive a username and password to access desired information. Once a user has received an account, he is able to login into various otherwise-restricted web pages and thus be presented with a dynamically generated web page representative of the level of access that the user's particular account possesses. From this initial dynamic web page, the user may access financial data related to a specific remote site, streaming media or data feeds from/regarding that site. If the user wishes, current data and audio/video information can be streamed to the user's web browser in real time.

Live productivity data is thus broadcast from remote drill site locations to the broadcast control center where it is delivered in real time to the users browser in a dynamic user-defined web page interface, the data is time stamped and cached in the archive server for on-demand replay with the corresponding archived video sequence.

A dynamic parameter setting feature allows the investor to select and set the productivity data to be displayed on a given remote site's dynamic web page. The following productivity data are an example of the data selectably available in real-time to the user: the current drilling depth and drilling footage rate; the current geologic formation and zone penetration; estimated remaining depth to the primary target zone; estimated remaining drill time to a primary target zone; sequential list of geological formations and zones penetrated by depth, formation tops and thickness of each zone with time stamp; rig condition and engine data including weight on line, rpm, torque, oil pressure, and water temperature; productivity data including operational activities such as drill bit checks, and bit condition reported with time stamp, next bit check, circulation time and mud condition on re-entry to continue drilling; mud pump pressure, circulation time, viscosity and weight reports with time stamp; and a mud loggers report of findings by depth and geologic sequence with posting of oil and gas shows.

The following items are examples of available data and information which are pre-loaded and delivered in real time on demand by the dynamic user-defined web page: verification statement by broadcast provider certifying video displays of the drilling rig (USGS or international global positioning coordinates and elevation); drilling permit number and classification from state, country or provincial authority or regulatory body; operator identification and drilling permit with lease and well site name, number, proposed total depth, location and well classification; target completion zone and target completion depth; well site spacing and density pattern, number of acres in drilling unit and well type; drilling rig owner and drilling rig specifications; targeted oil and gas zones including field name and geologic zones of interest; proposed total vertical depth, horizontal displacement, length and bottom hole location; sequential list of geological formations to be penetrated with anticipated tops of potential oil and gas producing zones; drilling operations schedule including site preparation and spud date; engineering specifications and drill plan, including surface casing and mud program; and drilling rig and mud pump capacities, condition and specifications.

Similarly, the dynamic interface capabilities of the web site according to the present invention similarly can be adapted to enable live financial and weather data on demand to the users browser for simultaneous viewing with the live remote site video feeds. Further, the dynamic interface web site also generates user-defined reports relating to the exploration and production history of the operator on demand by the user. These reports can assist investors, for example, in making online investments decisions as is described below.

FIG. 4 is a screenshot depiction of a client web browser display of a web page 400 for viewing data and multiple streaming media feeds 401 transmitted from a remote site on demand over the Internet according to preferred embodiments of the present invention. As depicted, a live (or archived) data feed 402 is merged with the streaming media feeds 401 to provide the most pertinent data and information in a single display. Additionally, web page 400 contains a textual description (name, location, etc.) and information 403 regarding the remote site and/or venture and navigation links 404 to other web pages, including dynamic web pages for other remote sites.

Similarly, FIG. 5 is a screenshot depiction of a client web browser display of a web page 500 for viewing detailed data and a single detailed streaming media feed 501 transmitted from a remote site on demand over the Internet according to preferred embodiments of the present invention. Web page 500 could be accessed, for example, by the user selecting one of the streaming media feeds 401 in web site 400 by clicking. New web page 500 thereby provides an expanded view of the particular selected camera feed. As shown in FIG. 5, web site 500 similarly contains a merged data feed, description of the remote site and selected camera feed 503, and navigation links 504.

According to preferred embodiments of the present invention, the dynamic interface web site additionally facilitates immediate investment transactions between investors and business ventures spanning various industries by allowing investors to purchase shares of ventures electronically. In such preferred embodiments, investors, once they become members of and log into the dynamic web site, are able to review prospective investments (such as by accessing company data on current and prior ventures) via investment web pages as well as by viewing streaming media information and data on demand via the various remote site web pages. On the investment web pages, oil and gas drilling investors, for example, could review the results of the last several wells drilled by a particular company. If the investor then desires to invest in the company, links are provided such that financial transactions can take place electronically (such as via credit card transactions, third-party electronic banking or brokerage services, wire transfers, etc.).

Financial and investment data, including prospective investment information data, is generated internally at the data server, coupled with numeric counter and time stamp for delivery by the web-server on-demand to the user. The data delivered describes the prospect name, operator, sales open date, sales close date, spud date, price per unit, and open interests. Additionally, prospectus Information and Investor Subscription Agreements are provided at the web site in compliance with respective regulatory and governing statutes and bodies.

Additionally, according to preferred embodiments of the invention, investors and managers can use a remote site event advisor tool over the interactive web site to request notifications regarding particular events of interest. The advisor tool according to such embodiments enables users to set alert status parameters to indicate what activities at a given remote site is of interest. Once these activities occur at the remote site (as recognized by the central system due to the type of information and data it is receiving from the remote site), the investor or manager is notified when the parameters are met. For example, an investor in an oil well could be provided with selectable alert parameters including that the drilling is nearing a target zone, that a gas kick has been reported, oil has been struck, a significant drill rate change has occurred and that a particular depth has been exceeded. Setting these parameters could then cause the central system to “look” for incoming information and data relevant to such events. Thus, for example, and email could be sent notifying an investor or manager to go on line and access the interactive web site to view live footage of a new, ongoing event. Alternatively, of course, a similar such notification to access the interactive web site could be sent to users through technologies such as instant and wireless messaging. Alternatively, an alert could cause a notice to be displayed on the interactive web site the next time the user logs on. This notice could provide a hyperlink that causes a dynamic redirection to a remote site web page and display of archived (or real-time) streaming media and data relating to the alert.

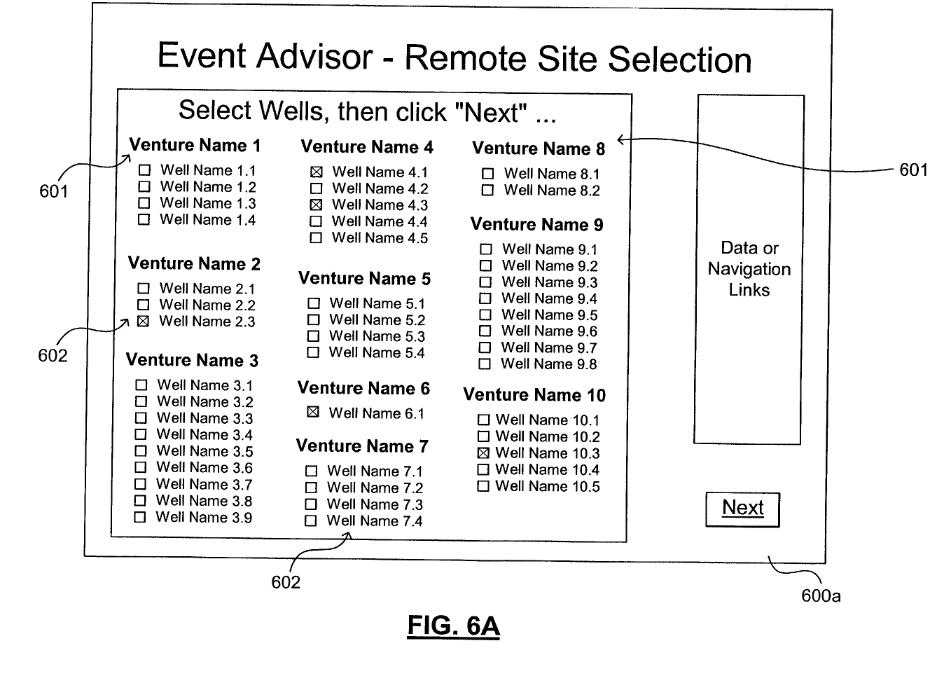

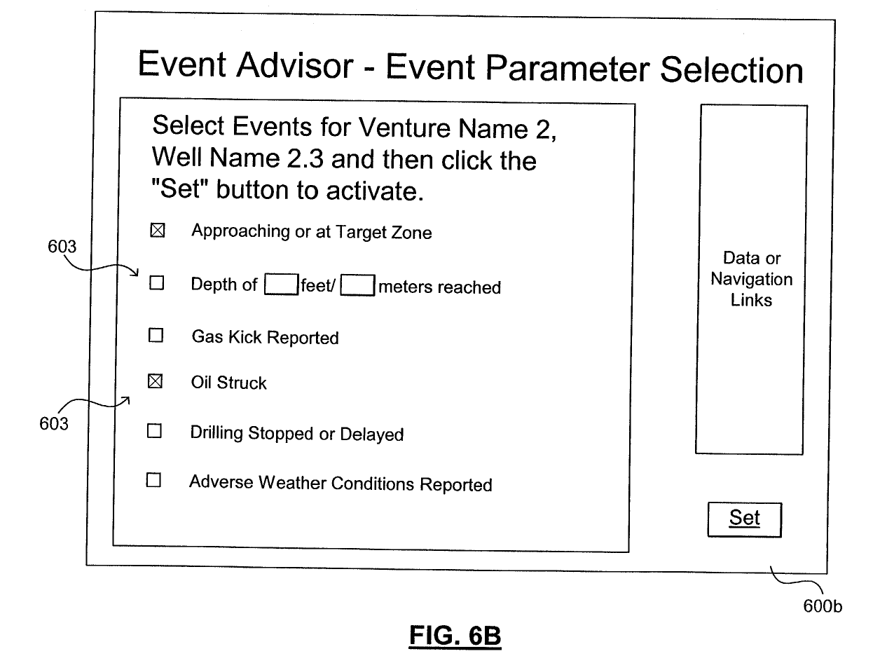

FIG. 6A and FIG. 6B are screenshot depictions of client web browser displays of a web pages 600a and 600b for viewing and selecting alert parameters 603 for particular ventures 601 and their various remote sites 602 using the remote site event advisor tool according to one preferred embodiment of the present invention. As depicted in FIG. 6A, when initiating the remote site event advisor tool over the Internet, a user is first provided with web page 600a. Preferably, web page 600a provides the user with a list of ventures 601 and associated remote sites 602 (e.g., oil wells) for which the advisor tool is available (e.g., oil and gas wells being currently drilled) such that the user can identify and select one or more remote sites for which he wishes to set alert parameters to receive notifications regarding the occurrence of events of interest. Once all desired remote sites are selected (depicted as employing HTML forms whereby those sites in which whose selection boxes are marked with an “x” are selected by the user), the user then proceeds to the second step (such as by selecting the “Next” button illustrated in FIG. 6A) that comprises selecting alert parameters.

Web page 600b as depicted by FIG. 6B depicts how the user then proceeds to select desired alert parameters 603 according to one preferred embodiment of the present invention. As with the selection of remote sites in web page 601 a, alert parameters 603 are preferably listed in an HTML form whereby the user can select desired alert parameters by clicking on check boxes and, if necessary, providing necessary supplemental input (such as a depth in feet of a well). It is anticipated that according to the present invention the types and amount of available alert parameters will differ from industry to industry, venture to venture, remote site to remote site. The six alert parameters shown in FIG. 6B are merely intended to illustrate potential parameter types suitable in the oil and gas industry.

Additionally, it should be noted that FIG. 6B depicts an embodiment whereby the alert parameters for each selected remote site is provided in a successive manner using separate web page displays (web page 601b depicts the individual alert parameter selection web page for “Well Name 2.3 for Venture Name 2”). Alternatively, of course, a single web page could be provided in which selectable alert parameters for each desired remote site are provided at the same time (thus eliminating the need for the user to load separate web pages for each selected remote site).

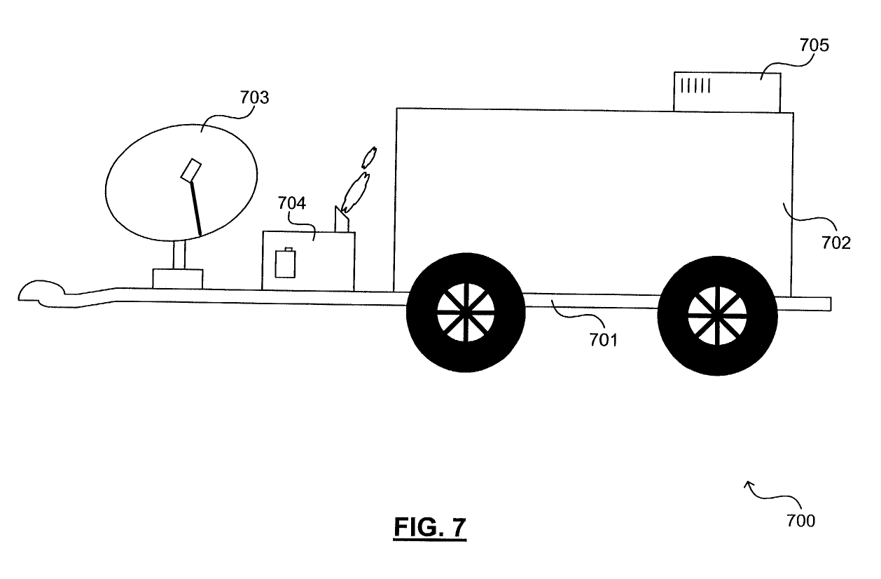

FIG. 7 is a diagram of portable remote site system 700 integrated into a trailer 701 according to one preferred embodiment of the present invention. The rugged trailer design depicted and contemplated allows for fast installation into and removal from a remote site location as well as provides protection of the equipment from damage and tampering. Such a portable integrated trailer system includes a hard, weather-proof housing 702 for enclosing the remote site capture server and other electronics, a satellite antenna 703 (serving as the remote site system transmission device to contact the central system), a power source (including but not limited to a gasoline generator 704 as depicted, or an AC plug, batteries, etc.) and optionally also a standby power source (such as a UPS, photo-voltaic battery cell combination, backup generator, etc.). Optionally, for climate control, an electrically operated climate control device 705, such as a dehumidifier, heater or air conditioning unit, can be included in the unit to keep the server housing within optimum operation temperatures and/or humidities in extreme climates.

The weather-proof housing 702 preferably is a 5 feet wide by 8 feet long by 6 feet wide enclosed structure that is permanently fixed onto the wheeled trailer 701. Within the housing is included a workbench, satellite receiver/transmitter (adapted to use VSAT technology), remote site camera interface equipment, and remote site capture server electronics for encoding and compressing the video/audio into digital format and sending it with accompanying data via the receiver/transmitter and satellite antenna. In preferred embodiments of the invention, the remote site capture server contained within such a portable remote site system 700 comprises a sturdy single-board design incorporating low power-consumption microprocessor chips, such as x86 chips, to conserve electricity in times when running AC power is not readily available. The software operating on the remote site capture server in such preferred embodiments also is written as kernel modules for a Linux operating system such that interaction with memory components and TCP/IP stacks can take place on a very low level, thus improving the overall speed and efficiency of the media stream capture and transmission.

As will be readily appreciated by one of ordinary skill in the art, the trailer-based remote site system 700 as depicted in FIG. 7 is only one preferred configuration for a remote site system. Many alternative configurations would equivalently serve to collect multi-media information and data and stream it to the central system for broadcasting and storage. For example, one of ordinary skill in the art will readily appreciate that the remote site system can alternatively comprise various separate known elements such as commercially available wireless/wireline digital cameras, a personal computer and a high speed data transmission connection. The present invention anticipates all such combinations and embraces them in the claims. In one such alternative embodiment, the RSCS is self-contained within a stand-alone compact weather and climate proof rugged housing, e.g., like a mini-tower computer. This tower RSCS housing would then serve as an all-weather, self-contained box that supports all the parts needed to capture the streaming media (e.g., video images from the cameras), compress them, and send them out of the remote site. By way of example, various suitable compact designs for satellite routers and transceivers are manufactured, such as those made available by Helius, Inc. of Lindon, Utah.

The preferred embodiments being thus described, various modifications of the embodiments herein disclosed will be readily apparent to one skilled in the art after reading the above. Any and all such modifications are intended to be covered by the invention as claimed.

What is claimed is:

1. A network for providing information and data access on demand to users regarding activity at remote locations, said network comprising:
at least one remote site system, said remote site system being located at a remote location and adapted to capture live multi-media information and data and then combine said information and data into digital streams;
a central collection and distribution system, said central system adapted to receive streams of said digital information and data electronically from said remote site system, store said digital information and data according to a location of origin, and transmit said received streams or stored digital information and data upon demand; and
at least one client device operable by a user, said client device being located remotely from said remote site system and adapted to electronically communicate with said central system wherein said client device allows said user to access and view said streams as they arrive at said central system and to access and view said stored digital information and data.

2. The network according to claim 1, wherein said user is an investor interested in activities occurring at said remote location, and wherein said central network allows said investor to use said client device to invest in ventures associated with said activities.

3. The network according to claim 2, wherein said ventures are in industries selected from the group consisting of oil and gas drilling, ranching, construction, crop production, mining, and forestry.

4. The network according to claim 3, wherein said multi-media information comprises video footage of activities taking place at said remote location.

5. The network according to claim 2, wherein said industry is oil and gas drilling.

6. The network according to claim 5, wherein said multi-media information comprises video footage of activities taking place at a remote oil and gas drilling location.

7. The network according to claim 1, wherein said multi-media information comprises video footage of activities taking place at said remote locations.

8. The network according to claim 1 further comprising a plurality of said remote site systems, each of said remote site systems being located at one of the remote locations.

9. The network according to claim 8, wherein said streams and said information and data allow said user to monitor activities taking place at said remote locations make decisions in light of said monitored activities.

10. The network according to claim 9, wherein said user is a manager or investor.

11. The network according to claim 9, wherein said client devices are electronically connected to said central network via the Internet.

12. The network according to claim 1, wherein said stored information and data are time stamped so as to allow said user to access said stored information and data according to a past time period of interest.

13. The network according to claim 1, wherein said users can access an event advisor to instruct said central system to monitor said streams as they arrive for indications of the occurrence of an event of interest.

14. The network according to claim 13, wherein said event advisor is adapted to provide user-selectable event parameters representing potential events of interest and wherein said event parameters are customized according to activities taking place at said remote location.

15. The network according to claim 14 further comprising a plurality of said remote site systems, each of said remote site systems being located at one of the remote locations, and wherein said event advisor customizes said event parameters for each remote location.

16. The network according to claim 1, wherein said remote site system sends said digital streams to said central system in real time over a satellite transmission network.

17. The network according to claim 1, wherein said remote site system comprises electronic data capture and transmission equipment integrated into a portable trailer, said equipment comprising a multi-media information and data capture server, a power source, and a electronic communications device.

18. The network according to claim 17, wherein said electronic communications device comprises a VSAT satellite dish and transmitter/receiver.

19. The network according to claim 4, wherein said remote site system comprises a plurality of cameras such that said user can access multiple feeds of multimedia information for a given remote location.

20. A method for providing users with on demand access to information and data gathered from remote sites, said method comprising:
collecting multi-media information and data at each remote site and compiling said information and data into a digital stream at each remote site, said multimedia information comprising video of activities taking place at said remote sites;
transmitting said digital streams from each of said remotes sites to a central collection and distribution system; and
re-transmitting a particular digital stream that originated from a requested remote site from said central collection and distribution system to a requesting user upon demand wherein said requesting user requests, receives and uses said digital stream with a computing device.

21. The method according to claim 20, wherein said activities comprise oil and gas well drilling, and wherein said user is selected from the group consisting of financial investors in said well drilling or managers of said drilling activities.

22. The method according to claim 21, wherein said managers are oil well operators.

23. The method according to claim 20, wherein multiple cameras are utilized to record multiple camera angles of said activities at each remote site.

24. The method according to claim 20 further comprising electronically archiving each said digital stream at said central collection and distribution system as said streams are received such that the users can access streams from past time periods upon demand.

25. The method according to claim 20 further comprising electronically storing each said digital stream at said remote site prior to transmitting said digital streams to said central collection and distribution system.

26. The method according to claim 20, wherein said transmitting step utilizes satellite transmission of said digital streams from said remote sites to said central collection and distribution system.

27. The method according to claim 20 wherein said computing device is electronically connected to said central collection and distribution system via the Internet.

28. The method according to claim 20 further comprising time stamping said digital streams as the arrive at said central collection and distribution system so as to allow said users to access said multi-medi information and data according to a past time period of interest.

29. The method according to claim 20, further comprising receiving instructions from a given user instructing said central collection and distribution system to monitor said digital streams as they arrive for indications of the occurrence of an event of interest.

30. The method according to claim 29, wherein said central collection and distribution system is adapted to provide user-selectable event parameters to said given user representing potential events of interest whereby said instructions are made by said given user by selecting potential event parameters relevant to said event of interest.

30. A network adapted to provide users with on demand access to information and data gathered from remote sites regarding activities at remote sites, said network comprising:
means for capturing said information and data from said remote sites, said means for capturing taking live multi-media information and data from said remote site and compiling said multi-media information and data into digital streams;
means for sending said compiled digital streams from said remote site to a central collection and distribution system;
said central collection and distribution system comprising means for receiving said digital streams from said remote sites, means for storing said received digital streams according to a time stamp and location of origin, and means for transmitting said received streams or stored digital streams upon demand; and
means for said users to electronically communicate with said central and distribution system, said means for communicating including a client device being located remotely from said remote site and adapted to electronically communicate with said central collection and distribution system wherein said client device allows said user to access and view live streams as they arrive at said central collection and distribution system and to access and view said stored digital streams.

31. The network according to claim 30, wherein said means for sending and said means for receiving electronically communicate via satellite data transmissions.

32. The network according to claim 30, wherein said user is an investor interested in said activities occurring at at least one of said remote sites, and wherein said central network allows said investor to use said client device to invest in ventures associated with said activities.

33. The network according to claim 30, wherein said multi-media information comprises video images of said activities.

34. The network according to claim 30, wherein said activities comprise oil and gas drilling at said remote sites.
